(19) United States
(12) Patent Application Publication
(10) Pub. No.: US 2026/0337114 A1
(43) Pub. Date: Oct. 29, 2026

(54) ORANGE-COLOURED ZIRCONIA-BASED, HOROLOGICAL COMPONENT; AND METHOD FOR MANUFACTURING AN ORANGE-COLOURED HOROLOGICAL COMPONENT

(71) Applicant: Comadur SA, Le Locle (CH)

(72) Inventors: Arnaud ACTIS-DATTA, Bassecourt (CH); Bagomed ALAUDINOV, Monthey (CH)

(73) Assignee: Comadur SA, Le Locle (CH)

(21) Appl. No.: 19/640,486

(22) Filed: Apr. 7, 2026

(30) Foreign Application Priority Data
Apr. 24, 2025 (EP) 25172243.5

(51) Int. Cl. C04B 35/48; B28B 11/24; G04D 99/00

(52) U.S. Cl. CPC C04B 35/48; B28B 11/243; G04D 99/00; C04B 2235/74

(57) ABSTRACT

An orange ceramic horological component, the component including zirconia in an amount by weight of between 87% and 98.8%, yttrium oxide in an amount by weight of between 1 and 6%, aluminium oxide in an amount by weight of between 0.1% and 5%, cerium oxide in an amount by weight of between 0.05% and 1%, and magnesium oxide in an amount by weight of between 0.05% and 1%.

### CROSS REFERENCE TO RELATED APPLICATION

This application claims priority to European Patent Application No. 25172243.5 filed Apr. 24, 2025, the entire contents of which are incorporated herein by reference.

### TECHNICAL FIELD

The present invention relates to a method for manufacturing an orange-coloured zirconia-based component by sintering.

The invention also relates to an orange zirconia-based component produced in particular according to the above method.

### PRIOR ART

Colouring agents or pigments such as cadmium sulphide (CdS), cadmium selenide (CdSe) and cadmium sulphoselenide are already commonly incorporated into ceramic materials to produce orange/red ceramic parts used, for example, to make enamels, glazes and containers for domestic use or for floor coverings.

The use of this type of colouring agent has a number of drawbacks when incorporating such colouring agents into industrial ceramics, particularly those based on sintered zirconia.

Indeed, these colouring agents lack stability at high temperatures and only exhibit their colouring characteristics up to 1,000 or 1,200°C. This greatly limits the use of this type of colouring agent and in particular makes it impossible to produce sintered zirconia-based pieces, as the temperatures at which zirconia is sintered are in any case higher than 1,100°C.

Moreover, the use of these types of colouring agents, which contain heavy metals, in objects intended to come into contact with a user's skin, such as a watchcase, is at least strongly discouraged, if not legally prohibited.

Furthermore, commercially available colouring agents of this type have a particle size that is incompatible with the production of a homogeneous mixture of zirconia powder.

### SUMMARY OF THE INVENTION

The present invention aims to remedy the aforementioned drawbacks by proposing a method for manufacturing an orange component based on sintered zirconia and, on the other hand, such a component produced in particular using this method, this component having satisfactory mechanical properties while exhibiting an orange colour at the core and on the surface.

To this end, the present invention relates to an orange ceramic horological component, the component comprising zirconia in an amount by weight of between 87% and 98.8%, yttrium oxide in an amount by weight of between 1% and 6%, aluminium oxide in an amount by weight of between 0.1% and 5%, cerium oxide in an amount by weight of between 0.05% and 1%, and magnesium oxide in an amount by weight of between 0.05% and 1%.

The invention also relates to a method for manufacturing an orange-coloured ceramic component.

More specifically, according to a first embodiment, the method for manufacturing an orange-coloured zirconia-based horological component according to the invention comprises the following steps:
preparing a first mixture comprising a zirconia powder, 1% to 6% by weight of yttrium oxide, 0.1% to 5% by weight of aluminium oxide, 0.05% to 1% by weight of cerium oxide, and 0.05% to 1% by weight of magnesium oxide;
preparing a second mixture comprising the first mixture and at least one binder;
preparing a powder mixture or a granulated mixture of the second mixture;
forming a green body from the powder mixture or granulated mixture;
debinding the green body to produce a brown body;
sintering the brown body in a neutral gas atmosphere to form an orange-coloured ebauche;
machining the resulting ebauche to produce the orange-coloured ceramic horological component.

According to a second embodiment, the method for manufacturing an orange-coloured zirconia-based horological component according to the invention comprises the following steps:
preparing a mixture comprising a zirconia powder, 1 to 6% by weight of yttrium oxide, 0.1% to 5% by weight of aluminium oxide, 0.05% to 1% by weight of cerium oxide, and 0.05 to 1% by weight of magnesium oxide;
readying a mould;
depositing the powder mixture in the mould;
performing flash or SPS sintering, carried out in a neutral gas atmosphere at a sintering pressure comprised between 5 N/mm2 and 250 N/mm2, for a complete cycle time comprised between 10 min and 180 min, to form an orange-coloured ceramic component;
unmoulding the resulting orange-coloured component;
applying a finish to the orange-coloured ceramic component;
machining the resulting ebauche to produce the orange-coloured ceramic horological component.

The present invention also relates to an orange ceramic horological component produced by the manufacturing method.

According to other advantageous variants of the invention:
the sintering step according to the first embodiment is carried out at a temperature comprised between 1,250° C and 1,650° C for a time comprised between 30 minutes and 4 hours;
the sintering step according to the second embodiment is carried out at a temperature comprised between 600° C and 1,650° C for a time comprised between 10 minutes and 180 minutes;
the neutral gas is chosen among argon, nitrogen or helium, or a mixture of at least two of these neutral gases;
the debinding step is thermal debinding or solvent debinding;
the thermal debinding step is carried out in air.

The invention also relates to a ceramic component with an orange colour.

Such a horological component is a horological component used as an external part or in the movement and is chosen from the list comprising a middle, a back, a bezel, a bezel insert, a button, a crown, a bracelet link, a buckle, a dial, a hand, a dial index, an oscillating mass and a plate.

Other features and advantages of the present invention will become apparent in the following description of a preferred embodiment, presented by way of non-limiting example with reference to the appended drawings.

### DETAILED DESCRIPTION

The present invention relates to a ceramic horological component such as an external part used in horology or in jewellery, or a horological component with an orange colour throughout its mass (or core) and on its surface.

By incorporating cerium oxide (CeO2) powder into the sintering mixture, the method of the invention makes it possible to lower the sintering temperatures and improve the mechanical properties (shock resistance). Cerium oxide also acts as one of the elements that determines the desired orange colour of the component.

According to the invention, the first mixture comprises between 0.05% and 1% by weight of cerium oxide powder (Ce+4 O2).

The invention also relates to an orange zirconia-based horological component produced in particular according to the method in accordance with the invention, the component being made of a part sintered from a moulded piece comprising a zirconium oxide matrix, 1% to 6% by weight of yttrium oxide, 0.1% to 5% by weight of aluminium oxide, 0.05% to 1% by weight of cerium oxide, and 0.05% to 1% by weight of magnesium oxide.

Such components have the advantage of being highly brilliant after polishing, making them particularly suitable for manufacturing horological components such as middles, bezels, crowns, buttons, oscillating masses, bars, plates and bracelet links.

Other characteristics and advantages of the invention will become apparent from the following description of an exemplary embodiment of the method of the invention.

The manufacturing method of the invention which will now be described in detail is one that makes it possible to produce a bright orange component based on sintered zirconia, the appearance and mechanical properties of which are particularly suitable for the production of constituent parts for wristwatches or for the production of any other decorative part.

The bright orange zirconia component produced using this method comprises 87% to 98.8% by weight of stabilised zirconia and the remainder by weight, namely 1.2% to 13% by weight of a vitreous phase produced using aluminium oxide and yttrium oxide alone or in combination, from 0.05% to 1% by weight of cerium oxide and from 0.05% to 1% by weight of magnesium oxide.

Zirconia is conventionally stabilised in the tetragonal phase using at least one stabiliser chosen among the group of oxides comprising yttrium oxide, magnesium oxide and calcium oxide, alone or in combination.

Magnesium oxide increases the clarity of the component produced, resulting in a brighter, more brilliant orange colour.

To produce this component, a method according to a first embodiment of the invention comprises the following steps:
a) preparing a first mixture comprising a zirconia powder, 1% to 6% by weight of yttrium oxide, 0.1% to 5% by weight of aluminium oxide, 0.05% to 1% by weight of cerium oxide, and 0.05% to 1% by weight of magnesium oxide;
b) preparing a second mixture comprising the first mixture and an at least one binder;
c) preparing a powder mixture or a granulated mixture of the second mixture;
d) forming a green body from the powder mixture or granulated mixture;
e) debinding the green body to produce a brown body;
f) sintering the brown body in a neutral gas atmosphere for 30 minutes to 4 hours at a temperature comprised between 1,250° C and 1,650° C to form an orange-coloured ebauche;
g) machining the resulting ebauche to produce the orange-coloured ceramic component to the required dimensions.

It should be noted that all these powders should preferably have a purity greater than 95%.

Once the powders have been weighed, the powders are mixed and homogenised in a humid environment using a slip, for example. In the final homogenisation phase, a binder is added.

The mixture is then dried, for example in a conventional atomiser.

The resulting powder is sieved to retain particles with a particle size of less than 200 µm. A person skilled in the art will also be able to produce granules without any particular difficulty.

The powder is then pressed into a mould with the configuration of the component to be produced in order to form a green body of the component.

The green body is then debinded to remove any remaining binder. Typically, the debinding is thermal debinding or solvent debinding. In the case of thermal debinding, it is carried out in air. Debinding the green body produces a brown body.

The brown body is then placed in a sintering furnace. It should be noted in this regard that sintering is carried out under partial pressure of a neutral gas. The brown body is then heated in a first phase with a ramp of 100° C to 300° C per hour to a target temperature comprised between 1,250° C and 1,650° C. In the second phase, the brown body is kept at this target temperature for a time comprised between thirty minutes and four hours.

The neutral gas is chosen among argon, nitrogen or helium, or a mixture of at least two of these neutral gases.

Once sintering is complete, the temperature is gradually lowered with a ramp of 100°C to 400°C per hour. This produces an ebauche, or the component in its near-final overall form, and the colour of the ebauche resulting from the sintering operation is orange. It should be noted that the colouring is produced throughout the mass, such that machining the component does not alter its colour in any way.

The brown body is sintered in an argon or nitrogen atmosphere, depending on the desired orange colour. In fact, the inventors surprisingly found that the orange tint of the final component varied depending on the gas used.

Such an orange-coloured horological component can also be obtained by SPS sintering (or flash sintering).

The orange ceramic component can thus be produced using a method according to a second embodiment of the invention, and comprises the following steps:
preparing a first mixture comprising a zirconia powder, 1 to 6% by weight of yttrium oxide, 0.1 to 5% by weight of aluminium oxide, 0.05% to 1% by weight of cerium oxide, and 0.05 to 1% by weight of magnesium oxide;
readying a mould;
depositing the powder mixture in the mould;
performing flash or SPS sintering, carried out in a neutral gas atmosphere and at a sintering pressure comprised between 5 N/mm2 and 250 N/mm2, for a complete cycle time comprised between 10 min and 180 min, to form an orange-coloured ceramic component;
unmoulding the resulting orange-coloured component;
applying a finish to the orange-coloured ceramic component;
optionally machining the resulting ebauche to produce the orange-coloured ceramic horological component to the required dimensions.

Preferably, the sintering step is carried out at a temperature comprised between 600° C and 1,650° C for a time comprised between 10 minutes and 180 minutes.

The ebauche is machined to the dimensions of the desired component.

The method can comprise laser ablation machining to form decorations in the component. The decorations can consist of indexes, a graduation or a logo, for example.

After laser ablation machining, the manufacturing method comprises a finishing (or completion) step such as polishing, satin-finishing, mattifying, etc.

The resulting ebauche can optionally be machined to produce the orange-coloured ceramic horological component in the desired dimensions.

The following examples illustrate the method according to the invention and the resulting material.

### Example 1 by weight

The powder mixture comprises, by weight, 93.95% of zirconia, 5% of yttrium oxide, 0.25% of aluminium oxide, 0.6% of cerium oxide and 0.2% of magnesium oxide. The ebauche was sintered at 1,400° C under an argon stream for 60 minutes and the resulting component has an orange colour.

### Example 2 by weight

The powder mixture comprises, by weight, 88.65% of zirconia, 6% of yttrium oxide, 5% of aluminium oxide, 0.25% of cerium oxide and 0.1% of magnesium oxide. The ebauche was sintered at 1,650° C under a nitrogen stream for 90 minutes and the resulting component has an orange colour.

1. An orange ceramic horological component, the component comprising zirconia in an amount by weight of between 87% and 98.8%, yttrium oxide in an amount by weight of between 1 and 6%, aluminium oxide in an amount by weight of between 0.1% and 5%, cerium oxide in an amount by weight of between 0.05% and 1%, and magnesium oxide in an amount by weight of between 0.05% and 1%.

2. A method for manufacturing an orange-coloured zirconia-based horological component according to claim 1, the method comprising the following steps:
preparing a first mixture comprising a zirconia powder, 1 to 6% by weight of yttrium oxide, 0.1 to 5% by weight of aluminium oxide, 0.05% to 1% by weight of cerium oxide, and 0.05 to 1% by weight of magnesium oxide;
preparing a second mixture comprising the first mixture and at least one binder;
preparing a powder mixture or a granulated mixture of the second mixture;
forming a green body from the powder mixture or granulated mixture;
debinding the green body to produce a brown body;
sintering the brown body in a neutral gas atmosphere to form an orange-coloured ebauche; and
machining the resulting ebauche to produce the orange-coloured ceramic horological component.

3. A method for manufacturing an orange-coloured zirconia-based horological component according to claim 1, the method further comprising the following steps:
preparing a first mixture comprising a zirconia powder, 1 to 6% by weight of yttrium oxide, 0.1 to 5% by weight of aluminium oxide, 0.05% to 1% by weight of cerium oxide, and 0.05 to 1% by weight of magnesium oxide;
readying a mould;
depositing the powder mixture in the mould;
performing flash or SPS sintering, carried out in a neutral gas atmosphere and at a sintering pressure comprised between 5 N/mm2 and 250 N/mm2, for a complete cycle time comprised between 10 min and 180 min, to form an orange-coloured ceramic component;
unmoulding the resulting orange-coloured component;
applying a finish to the orange-coloured ceramic component;
machining the resulting ebauche to produce the orange-coloured ceramic horological component.

4. The manufacturing method according to claim 2, wherein the sintering step is carried out at a temperature comprised between 1,250° C and 1,650° C for a time comprised between 30 minutes and 4 hours.

5. The manufacturing method according to claim 3, wherein the sintering step is carried out at a temperature comprised between 600° C and 1,650° C for a time comprised between 10 minutes and 180 minutes.

6. The manufacturing method according to claim 2, wherein the neutral gas is chosen among argon, nitrogen or helium, or a mixture of at least two of these neutral gases.

7. The method according to claim 2, wherein the debinding step is thermal debinding or solvent debinding.

8. The method according to claim 7, wherein the thermal debinding step is carried out in air.

9. An orange ceramic horological component produced by the method according to claim 2, wherein the horological component is a component used as an external part or in the movement.

10. The horological component according to claim 9, wherein the horological component used as an external part or in the movement is chosen from the list comprising a middle, a back, a bezel, a bezel insert, a button, a crown, a bracelet link, a buckle, a dial, a hand, a dial index, an oscillating mass and a plate.
